(19) United States
(12) Patent Application Publication
(10) Pub. No.: US 2021/0057929 A1
(43) Pub. Date: Feb. 25, 2021

(54) DEVICE AND METHOD FOR INDEPENDENT CHARGE CONTROL OF A MULTIPLE PORT BATTERY CHARGER

(71) Applicant: Renesas Electronics America Inc., Milpitas, CA (US)

(72) Inventors: Yang LI, Fremont, CA (US); Sungkeun LIM, Cary, NC (US); Zhigang LIANG, Fremont, CA (US)

(73) Assignee: Renesas Electronics America Inc., Milpitas, CA (US)

(21) Appl. No.: 16/990,772

(22) Filed: Aug. 11, 2020

Related U.S. Application Data
(60) Provisional application No. 62/889,259, filed on Aug. 20, 2019.

(51) Int. Cl. H02J 7/00; H02J 7/04; H02M 3/158

(52) U.S. Cl. CPC H02J 7/00714; H02J 2207/40; H02M 3/1582; H02J 7/04

(57) ABSTRACT

Exemplary implementations include a device with a first battery manager circuit operatively coupled to a system voltage node and a battery node, a second battery manager circuit operatively coupled to the system voltage node and the battery node, a first charger circuit operatively coupled to the first battery manager circuit to receive a first current sensing input and transmit a first battery control signal, and a second charger circuit operatively coupled to the second battery manager circuit to receive a second current sensing input and transmit a second battery control signal. Exemplary implementations also include a device with a first battery manager operable to sense a first charging current, a second battery manager operable to sense a second charging current, a first charger circuit operable to obtain a first charger current parameter and to charge a battery from a first converter based on the first sensed current, and a second charger circuit operable to obtain a second charger current parameter and to charge the battery from a second converter based on the second sensed current.

### CROSS-REFERENCE TO RELATED PATENT APPLICATIONS

This application claims priority to U.S. Provisional Patent Application Ser. No. 62/889,259, entitled “Multiple Ports Battery Charger Independent Charge Control Method,” filed Aug. 20, 2019, the contents of such application being hereby incorporated by reference in its entirety and for all purposes as if completely and fully set forth herein.

### TECHNICAL FIELD

The present implementations relate generally to electrical chargers, and more particularly to independent charge control of a multiple port battery charger.

### BACKGROUND

Conventional system battery charger products cannot effectively support systems having a multiple power input ports coupled to a single battery. It advantageous to support two or more ports and chargers for one or more battery stacks. Such systems cannot be supported by existing battery charger products. Accordingly, a solution to these and other problems is needed.

### SUMMARY

Exemplary implementations include a device with a first battery manager circuit operatively coupled to a system voltage node and a battery node, a second battery manager circuit operatively coupled to the system voltage node and the battery node, a first charger circuit operatively coupled to the first battery manager circuit to receive a first current sensing input and transmit a first battery control signal, and a second charger circuit operatively coupled to the second battery manager circuit to receive a second current sensing input and transmit a second battery control signal. Exemplary implementations also include a device with a first battery manager operable to sense a first charging current, a second battery manager operable to sense a second charging current, a first charger circuit operable to obtain a first charger current parameter and to charge a battery from a first converter based on the first sensed current, and a second charger circuit operable to obtain a second charger current parameter and to charge the battery from a second converter based on the second sensed current.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates an exemplary system in accordance with present implementations.

FIG. 2 illustrates an exemplary device in accordance with present implementations.

FIG. 3 illustrates an exemplary charger in accordance with present implementations.

FIG. 4 illustrates an exemplary timing diagram for battery charging in accordance with present implementations.

FIG. 5 illustrates an exemplary method for battery charging in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

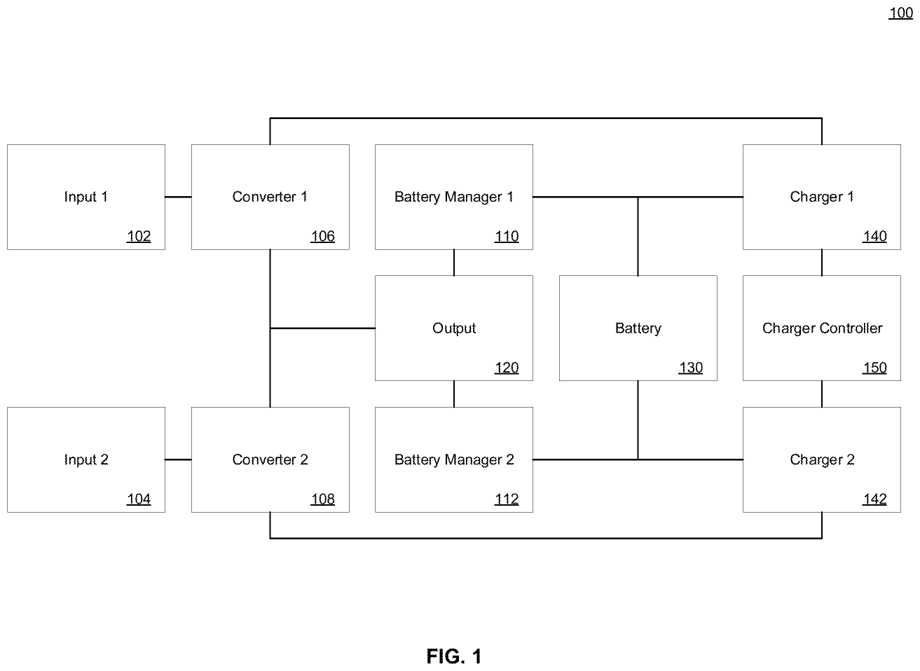

FIG. 1 illustrates an exemplary system in accordance with present implementations. As illustrated in FIG. 1, an exemplary system 100 includes a first input 102, a first converter 106, a first battery manager 110, a first charger 140, a second input 104, a second converter 108, a second battery manager 112, a second charger 142, an output 120, a battery 130, and a charger controller 150.

The first and second inputs 102 and 104 include a source of electrical power, voltage, current, or the like for supplying power to the system 100. In some implementations, the first and second inputs 102 and 104 include, but are not limited to regulated 120 V AC power, regulated 220V AC power, 5V DC power, 12V DC power, or the like. In some implementations, the first and second inputs 102 and 104 include a wired power connection, a wireless direct contact power connection, a wireless and contactless power connection, the like, or any power connection as is known or may become known. In some implementations, the first and second inputs 102 and 104 include one or more USB terminals or ports (e.g., USB-C, USB-PD).

The first and second converters 106 and 108 include one or more one or more electrical, electronic, electromechanical, electrochemical, or like devices or systems for charging or discharging the load 104. In some implementations, at least one of the first and second converters 106 and 108 include a DC-DC power converter. In some implementations, at least one of the first and second converters 106 and 108 include an inductive charger. An inductive charger may be, but is not limited to, a buck charger, a boost charger, a buck-boost charger, a combination thereof, or the like.

The first and second battery managers 110 and 112 include one or more electrical, electronic, logical, or like devices for sensing and directing current, voltage, power and the like flowing to the battery 130 from at least one of the first and second converters 106 and 108. In some implementations, at least one of the first and second battery managers 110 and 112 manage power delivery from a respective one of the first and second converters 106 and 108. In some implementations, the first and second battery managers 110 and 112 independently manage one or more aspects of a respective one of the first and second converters 106 and 108. In some implementations, the first and second battery managers 110 and 112 operate in a manner complementary to each other, to coordinate alternating or otherwise coordinating charging of the battery 130 from each of the first and second converters 106 and 108.

The first and second chargers 140 and 142 include one or more electrical, electronic, logical, or like devices for applying charge to the battery 130. In some implementations, the first and second chargers 140 and 142 include one more electrical circuits, digital electronic devices, analog electronic devices, integrated circuit devices, or the like as are known or may become known. In some implementations, at least one of the first and second chargers 140 and 142 receive electrical feedback from at least one of the first and second battery managers 110 and 112, controlling at least one switch of at least one of the first and second battery managers 110 and 112, and controlling at least one switch of at least one of the first and second converters 106 and 108. In some implementations, the charger controller 150 includes one or more electrical, electronic, logical, or like devices for generating at least one control signal for operating at least one of the first and second converters 106 and 108.

The output 120 includes one or more electrical, electronic, electromechanical, electrochemical, or like devices or systems for receiving power, voltage, current, or the like from one or more of the first converter 106, the second converter 108, and the battery 130 to perform one or more actions. In some implementations, the output 120 includes at least one battery, electronic display, electronic computer, electronic input device, electromechanical input device, electronic output device, electromechanical output device or the like. Examples of these devices include notebook computers, desktop computers, tablets, smartphones, printers, scanners, telephony endpoints, videoconferencing endpoints, keyboards, mice, trackpads, gaming peripherals, monitors, televisions, and the like. In some implementations, the output 120 includes one or more devices partially or fully separable from the system 100. In some implementations, the output 120 includes one or more devices partially or fully integrated or integrable into, or separable from, the system 100.

The battery 130 includes one or more electrical, electronic, electromechanical, electrochemical, or like devices or systems for at least one of receiving, storing and distributing input power. In some implementations, the battery 130 includes one or more stacks of batteries. In some implementations, the battery 130 includes lithium-ion or like energy storage. In some implementations, the battery 130 is integrated with, integrable with, or separable from the system 100. In some implementations, the battery 130 includes a plurality of battery units variously or entirely integrated with, integrable with, or separable from the system 100.

The charger controller 150 include one or more electrical, electronic, logical, or like devices for supplying power, voltage, current, or the like to one or more of the first and second chargers 140 and 142. In some implementations, the charger controller 150 includes an electronic controller (EC) controlling overall operation of the system 100.

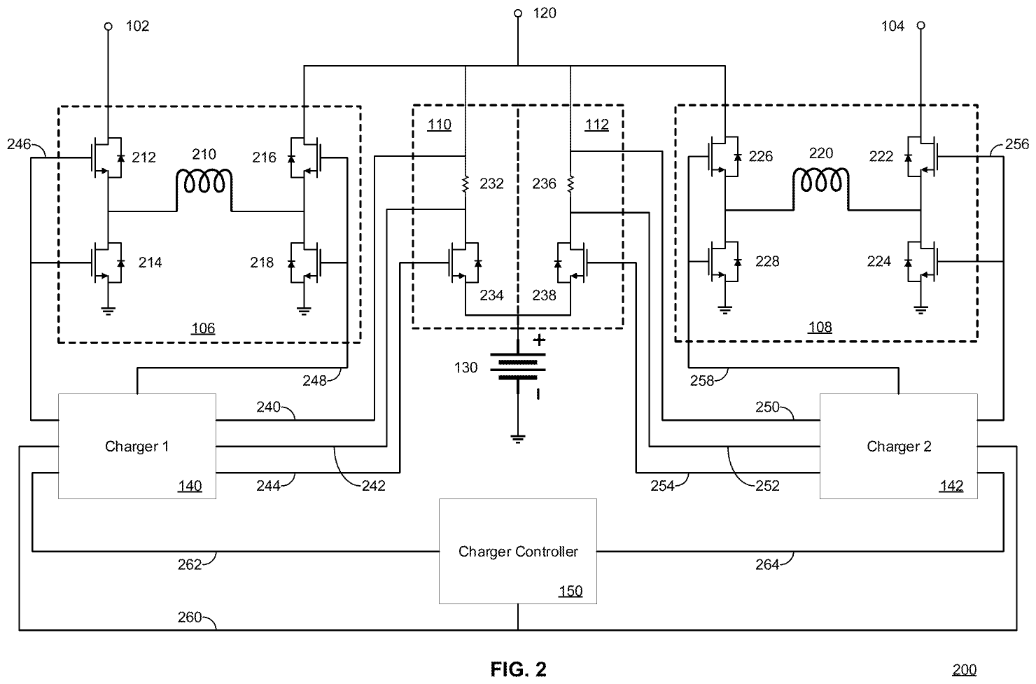

FIG. 2 illustrates an exemplary device in accordance with present implementations. In some implementations, the exemplary device 200 includes one or more discrete electrical, electronic, or like elements assembled on a printed circuit board, a solderless circuit board (e.g., a “breadboard”) or the like. In some implementations, one or more elements of the exemplary device 200 is fabricated in an integrated circuit or multiple integrated circuits assembled on a printed circuit board, a solderless circuit board, or the like. In some implementations, one or more portions or components of the exemplary device 200 are implemented in one or more programmable or reprogrammable devices or systems. While various devices are described by way of example as power MOSFETs, it is to be understood that exemplary systems in accordance with the present implementations may include one or more transistors of various types in addition to or instead of power MOSFETs. Exemplary transistors of various types include, but are not limited to, FETs, MOSFETs, IGBTs, and BJTs as are known or may become known. As illustrated in FIG. 2, an exemplary device 200 includes the first input 102, the first converter 106, the first battery manager 110, the first charger 140, the second input 104, the second converter 108, the second battery manager 112, the second charger 142, the output 120, the battery 130, and the charger controller 150.

The first converter 106 and the second converter 108 each convert power received respectively from the input 102 and the input 104, and supply converted power to the output 120. In some implementations, the output 120 is a system voltage node supplying voltage to one or more electronic devices or systems integrated with or integrable with the device 200. The exemplary converter 106 of the device 200 includes a high-side buck transistor 212, a low-side buck transistor 214, a high-side boost transistor 216, a low-side boost transistor 218, and an inductor 210. Correspondingly, the exemplary converter 108 of the device 200 includes a high-side buck transistor 222, a low-side buck transistor 224, a high-side boost transistor 226, a low-side boost transistor 228, and an inductor 220.

In the exemplary device 200, the transistors of the first and second converters 106 and 108 are variously coupled to one or more gate driver lines to effectuate closing and opening of those transistors and to effectuate operation of the first and second converters 106 and 108. In some implementations, the buck transistors 212 and 214 are operatively coupled to the first charger 140 by a first buck-side driver line 236, and the boost transistors 216 and 218 are operatively coupled to the first charger 140 by a first boost-side driver line 238. Correspondingly, in some implementations, the buck transistors 222 and 224 are operatively coupled to the second charger 142 by a second buck-side driver line 246, and the boost transistors 226 and 228 are operatively coupled to the second charger 142 by a second boost-side driver line 248. It is to be understood that one or more amplifiers, filters, sensors, controllers, or the like may be operatively coupled between any of the transistors 212, 214, 216 and 218, and the driver lines 236 and 238. It is to be further understood that one or more amplifiers, filters, sensors, controllers, or the like may additionally or alternatively be operatively coupled between any of the transistors 222, 224, 226 and 228, and the driver lines 246 and 248.

The first battery manager 110 includes a current sensor and a battery gate control circuit. In some implementations, a current sensor and a battery gate control circuit of the first battery manager 110 respectively include a sense resistor 232 and a battery gate transistor 234 coupled in series with the output 120 and the battery 130. In some implementations, current flows from the converter 106 to the battery 130 through the output 120. In this exemplary scenario, the first battery manager 110 causes a voltage drop across the sense resistor 232 coupled between the output 120 and the battery gate transistor 234. In some implementations, the first battery manager 110 is operatively coupled or couplable to a first high-side feedback line 240 and a first low-side feedback line 242 respectively coupled to a high side and a low side of the sense resistor 232. The first charger 140 can determine a magnitude of current flowing through the sense resistor 232, and thus flowing from the converter 106, based on a difference in voltage between the feedback lines 240 and 242. In some implementations, the second battery manager 112 includes a current sensor and a battery gate control circuit correspondingly to the first battery manager 110. In some implementations, the second battery manager 112 includes a sense resistor 236 and a battery gate transistor 238 corresponding to the sense resistor 232 and a battery gate transistor 234. Correspondingly, the second charger 142 can determine a magnitude of current flowing through the sense resistor 236, and thus flowing from the converter 108, based on a difference in voltage between the feedback lines 250 and 252. Thus, the first and second chargers 140 and 142 can respectively detect each current flowing respectively from the first and second converters 106 and 108. In some implementations, the first battery gate transistor 234 and the second battery gate transistor 238 are operatively coupled respectively to a first battery gate control line 244 and a second battery gate control line 254.

The first charger 140 and the second charger 142 of the device 200 are operably coupled to receive input respectively from the first battery manager 110 and the second battery manager 112, and to transmit output respectively to the first converter 106 and the second converter 108. The first charger 140 and the second charger 142 of the device 200 are further operably coupled to receive input from the charger controller. It is to be understood that the coupling of the charger is not limited to the lines or the devices discussed herein. The first charger 140 is operably coupled to the first high-side feedback line 240 and the first low-side feedback line 242, to sense a first charging current flowing through the first battery charger 110. In some implementations, the first charger 140 is further operably coupled to the first battery gate control line 244, to drive the first battery gate transistor 234. The first charger 140 can couple the battery 130 to the first converter 106 through the first battery gate transistor 234. In some implementations, the first charger 140 couples the battery 130 to the first converter 106 through the first battery gate transistor 234 during a portion of a charging cycle associated with the first converter, and the second charger 142 couples the battery 130 to the second converter 108 through the second battery gate transistor 238 during a portion of a charging cycle associated with the second converter. In some implementations, the second charger 142 includes a second high-side feedback line 250 and a second low-side feedback line 252, to sense a second charging current flowing through the second battery manager 112, correspondingly to the first charger 140. In some implementations, the second charger 142 is further operably coupled to the second battery gate control line 254, to drive the second battery gate transistor 238, correspondingly to the first charger 140. In some implementations, the first charger 140 alternatingly activates and deactivates the first battery gate transistor 234 while the second charger 142 alternatingly deactivates and activates the second battery gate transistor 234. Thus, the first and second chargers can alternatingly charge the battery 130 from both the first and second converters 106 and 108.

The charger controller 150 can supply a first charging signal by a first charging signal line 262 to the first charger 140, a second charging signal by a second charging signal line 264 to the second charger 142, and a reference signal by a reference signal line 260 to the first and second chargers 140 and 142. In some implementations, the first and second charging signals are each currents of the same or differing values. As one example, the first charging signal 262 is a first current of 1 A and the second charging signal 264 is a second current of 2 A. In some implementations, the reference signal 260 is based on the first and second charging signals 262 and 264. In some implementations, the reference signal 260 is a current aggregated from first and second charging currents. As one example, the reference signal 260 is a reference current of 3 A based on a sum of an exemplary first charging current of 1 A and an exemplary second charging current of 2 A.

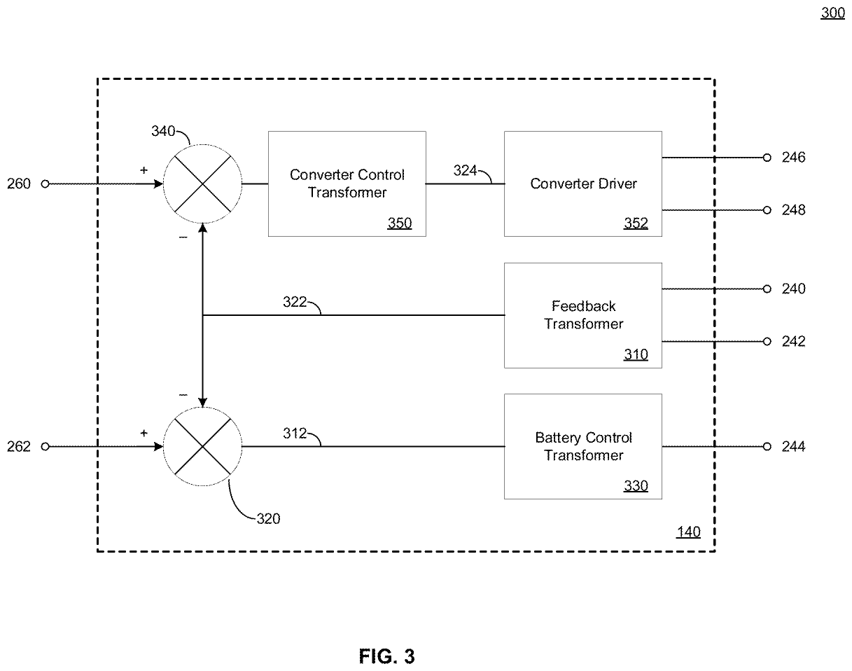

FIG. 3 illustrates an exemplary charger in accordance with present implementations. As illustrated in FIG. 3, an exemplary charger 300 includes a feedback transformer 310, a charger signal summing circuit 320, a battery control transformer 330, a reference signal summing circuit 340, a converter control transformer 350, and a converter driver 352. As illustrated in FIG. 3, the charger 300 corresponds to the first charger 140. However, it is to be understood that the charger 300 can also correspond to the second charger 142, allowing the system 100 and the device 200 to implement a corresponding structure and operation for the first and second chargers 140 and 142. The feedback transformer 310 receives output from the current sensor and outputs a feedback signal based on the output from the current sensor. In some implementations, the feedback transformer receives input from the high-side feedback line 240 and the low-side feedback line 242, and outputs a feedback signal to the feedback line 322. In some implementations, the feedback transformer generates a root-mean-square voltage from received feedback including one or more AC components.

The charger signal summing circuit 320 generates a preliminary battery control signal and transmits the preliminary battery control signal to a control transformer 330. In some implementations, the charger signal summing circuit 320 receives the charging signal 262 and the feedback signal 322. In some implementations, the charger signal summing circuit 320 receives the charging signal 262 at a high side of the circuit and receives the feedback signal 322 at a low side of the circuit. In some implementations, the charger signal summing circuit 320 generates the preliminary battery control signal by subtracting a value of the feedback signal 322 from a value of the charging signal 262. In some implementations, values of the feedback signal 322 and the charging signal 262 are voltage magnitudes. The battery control transformer 330 generates a battery control signal 312 to activate or deactivate a gate control circuit of at least one of the first and second battery managers 110 and 112. In some implementations, the battery control transformer includes one or more electrical, electronic, logical, or like devices for modifying the gate control signal to be compatible with the gate control circuit. In some implementations, the charger signal summing circuit 320 generates a voltage difference transformation and the battery control transformer 330 generates a signal magnitude transformation. In some implementations, the charger signal summing circuit 320 and the battery control transformer 330 either individually or together define an electrical or electronic circuit operable to perform one or more signal transformations thereof.

The reference signal summing circuit 340 generates a preliminary converter control signal and transmits the preliminary converter control signal to a control transformer 330. In some implementations, the reference signal summing circuit 340 receives the reference signal 260 and the feedback signal 322. In some implementations, the reference signal summing circuit 340 receives the reference signal 260 at a high side of the circuit and receives the feedback signal 322 at a low side of the circuit. In some implementations, the reference signal summing circuit 340 outputs a control signal by subtracting a value of the feedback signal 322 from a value of the reference signal 260. The converter control transformer 350 generates a converter control signal 324 to activate or deactivate at least one transistor of the first converter 106 or the second converter 108. In some implementations, the converter control transformer 350 includes one or more electrical, electronic, logical, or like devices for generating the converter control signal to be compatible with the converter driver. In some implementations, the charger signal summing circuit 320 generates a voltage difference transformation and the battery control transformer 330 generates a signal magnitude transformation. In some implementations, the reference signal summing circuit 340 and the converter control transformer 350 either individually or together define an electrical or electronic circuit operable to perform one or more signal transformations thereof. In some implementations, the reference signal summing circuit 340 and the converter control transformer 350 either individually or together generate a pulse-width modulated signal for controlling the first converter 106 or the second converter 108, in response to varying input received. In some implementations, varying input is received from the charger controller 150.

The converter driver 352 generates one or more signals to drive operation of the first converter or the second converter. In some implementations, the converter driver receives the converter control signal 324 and generates the buck-side driver signal 246 and the boost-side driver signal 248 based on the converter control signal 324. In some implementations, the converter driver includes one or more amplifiers, filters, sensors, controllers, or the like.

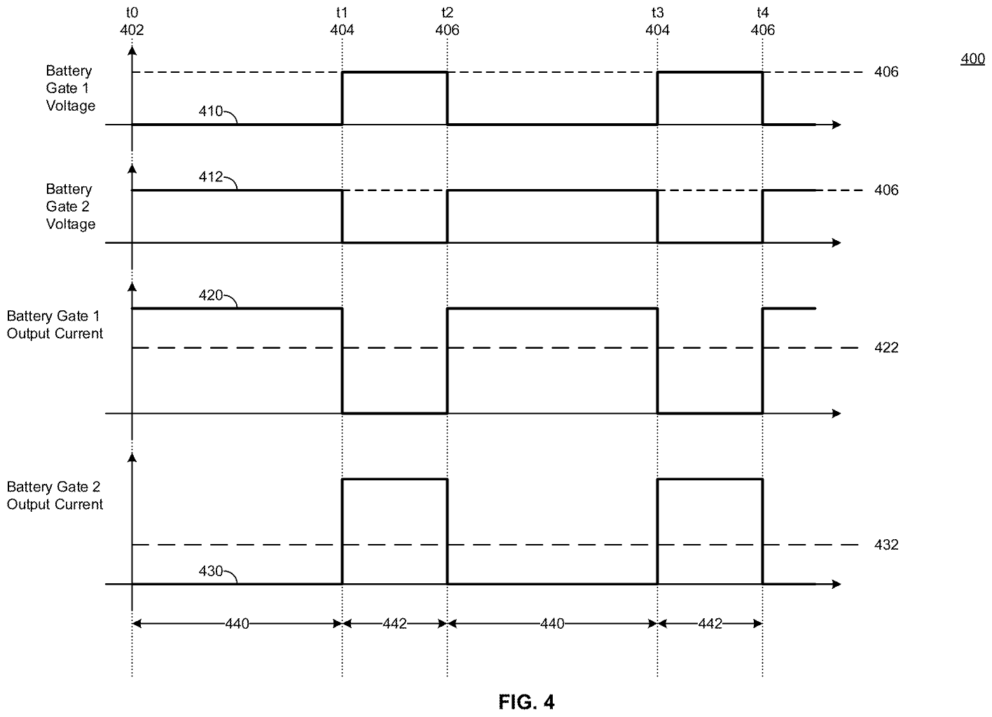

FIG. 4 illustrates an exemplary timing diagram for battery charging in accordance with present implementations. As illustrated by way of example in FIG. 4, an exemplary system may operate according to voltage and current timing in exemplary timing diagrams 400. In some implementations, a first exemplary voltage 410 across the first sense resistor 232 varies from time t0 402 through time t4 404, and a second exemplary voltage 412 across the second sense resistor 236 varies from time t0 402 through time t4 404. Concurrently, in some implementations, a first output current 420 of the first charger 140 varies from time t0 402 through time t4 406, and a second output current 430 of the second charger 142 varies from time t0 402 through time t4 406. In some implementations, the exemplary system can undergo multiple sequential cycles. In some implementations, multiple sequential cycles include a first duty period 440 and a second duty period 442.

In some implementations, a duty cycle for the exemplary system is based on the reference signal 260, the charging signal 262, and the second charging signal 264. In some implementations, one or more of the first and second chargers 140 and 142 include one or more electronic circuits implementing at least one transfers function. In some implementations, the transfer function is in accordance with one or more of the feedback transformer 310, the charging signal summing circuit 320, the battery control transformer 330, the reference signal summing circuit 340, and the converter control transformer, and the inputs and outputs therewith. In some implementations, a proportion of a charger current (I_{chg}) to a reference current (I_{ref}) defines a duty cycle “on time” for a charger. Further, the first charger 140 and the second charger 142 can generate differing and complementary duty cycle “on time” periods where each receives a differing current. Thus, an exemplary first duty cycle “on time” duty (D₁) for the first charger 140, and an exemplary second duty cycle “on time” duty (D₂) for the second charger 142, are:

$$\begin{matrix}{D}_{1} = \frac{{I}_{chg , 1}}{{I}_{r e f}} = \frac{{I}_{chg , 1}}{( {I}_{chg , 1} + {I}_{chg , 2} )} & Eq . ( 1 ) \\ {D}_{2} = \frac{{I}_{chg , 2}}{{I}_{r e f}} = \frac{{I}_{chg , 2}}{( {I}_{chg , 1} + {I}_{chg , 2} )} & Eq . ( 2 )\end{matrix}$$

As one example, where I_{chg,1} is 2 A and I_{chg,2} is 1 A, D₁ is ⅔ and D₂ is ⅓. Further, the first charger 140 and the second charger 142 can generate differing charge currents applied to the battery 130. In some implementations, average charge currents associated with the first charger 140 and the second charger 142 are respective products of their respective duty cycle “on time” duties and the received total current Iₜₒₜₐₗ from both converters 106 and 108. Thus, an exemplary first average current 422 (Ī₁) for the first charger 140, and an exemplary second average current 432 (Ī₁) for the second charger 142, are:

$$\begin{matrix}\overline{{I}_{1}} = {I}_{total} \frac{{I}_{chg , 1}}{( {I}_{chg , 1} + {I}_{chg , 2} )} = {I}_{tota l} \frac{{I}_{chg , 1}}{{I}_{r e f}} & Eq . ( 3 ) \\ \overline{{I}_{2}} = {I}_{total} \frac{{I}_{chg , 2}}{( {I}_{chg , 1} + {I}_{chg , 2} )} = {I}_{total} \frac{{I}_{chg , 2}}{{I}_{r e f}} & Eq . ( 4 )\end{matrix}$$

As one example, where Iₜₒₜₐₗ is I_{ref}, Ī₁ is I_{chg,1} and Ī₂ is I_{chg,2}. Thus, the first charger 140 and the second charger 142 can generate multiple variable duty cycles and can generate multiple variable average currents for charging the battery 130, including but not limited to currents 422 and 432. In some implementations, the charger controller supplies various charger and reference signals to implement various duty cycles for the exemplary system.

The exemplary timing diagram of FIG. 4 illustrates a plurality of exemplary duty cycles, including the first output current 420 for the first battery gate transistor 234 of the first charger 140, and the second output current 430 for the second battery gate transistor 238 of the second charger 142. At time t0 402, the exemplary system is in the first duty period 440. The first battery gate transistor 234 is off, with a first battery gate voltage in a “low” state below a gate activation threshold voltage 406. Concurrently, the second battery gate transistor 238 is on, with a second battery gate voltage in a “high” state at or above the gate activation threshold voltage 406. Concurrently, the first duty cycle 420 is in an “on time” state supplying current to the battery 130, and the second duty cycle 430 is in an “off time” state not supplying current to the battery 130.

At time t1 404, the exemplary system switches from the first duty period 440 to the second duty period 442. The first battery gate transistor 234 is on, with a first battery gate voltage in a “high” state at or above the gate activation threshold voltage 406. Concurrently, the second battery gate transistor 238 is off, with a second battery gate voltage in a “low” state below the gate activation threshold voltage 406. Concurrently, the first duty cycle 420 is in an “off time” state not supplying current to the battery 130, and the second duty cycle 430 is in an “on time” state supplying current to the battery 130.

At time t2 406, the exemplary system switches from the second duty period 442 back to the first duty period 440. The state of the exemplary system at time t2 406 corresponds to the state of the exemplary system at state t0 402. At time t3 404, the exemplary system switches from the first duty period 440 back to the second duty period 442. The state of the exemplary system at time t3 404 corresponds to the state of the exemplary system at state t1 404. At time t4 406, the exemplary system switches from the second duty period 442 back to the first duty period 440. The state of the exemplary system at time t4 406 corresponds to the state of the exemplary system at states t0 402 and t2 406.

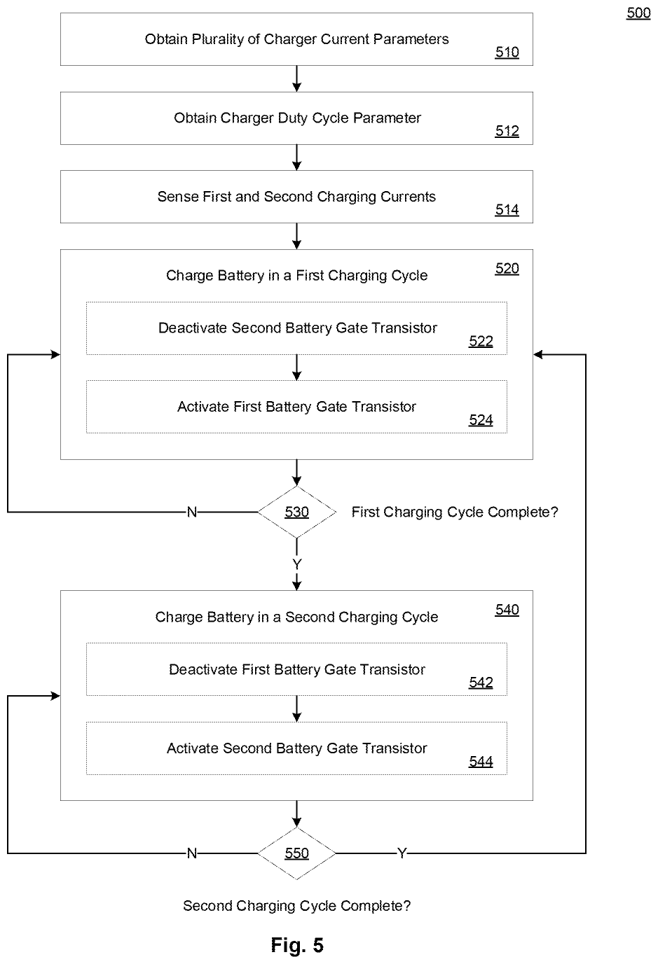

FIG. 5 illustrates an exemplary method for battery charging in accordance with present implementations. In some implementations, at least one of the exemplary system 100 and the exemplary device 200 performs method 500 according to present implementations.

At step 510, an exemplary system obtains a plurality of charger current parameters. In some implementations, the charger controller 150 generates one or more of the charger current parameters. In some implementations, the charger current parameters include the reference signal 260 and the first and second charging signals 262. The method 500 then continues to step 512. At step 512, the exemplary system obtains a charger duty cycle parameter. In some implementations, at least one of the first charger 140 and the second charger 142 obtains the duty cycle parameter. In some implementations, at least one of the first charger 140 and the second charger 142 obtains a duty cycle parameter based on one or more of the feedback transformer 310, the charger signal summing circuit 320, the battery control transformer 330, the reference signal summing circuit 340, and the converter control transformer 350. The method 500 then continues to step 514. At step 514, the exemplary system senses the first and second charging currents. In some implementations, at least one of the first charger 140 and the second charger 142 respectively sense the first and second charging currents. In some implementations, the first charger 140 and the second charger 142 respectively sense the first and second charging currents respectively through the first and second sense resistors 232 and 236. The method then continues to step 520.

At step 520, the exemplary system charges the battery 130 in a first charging cycle. In some implementations, the first charging cycle corresponds to the first duty period 440. In some implementations, the first charging cycle corresponds to one or more time periods t0 402, t2 406, and t4 406. In some implementations, the step 520 includes one or more of steps 522 and 524. At step 522, the exemplary system deactivates the second battery gate transistor 238. At step 524, the exemplary system activates the first battery gate transistor 234. The method 500 then continues to step 530.

At step 530, the exemplary system determines whether the first charging cycle is complete. If the exemplary system determines that the first charging cycle is complete, the method 500 continues to step 540. If the exemplary system determines that the first charging cycle is not complete, the method 500 continues to step 520. In some implementations, one or more of the charger controller 150, the first charger 140, and the second charger 142 determines whether the first charging cycle is complete based on one or more electrical, electronic, or logical conditions, or a combination thereof.

At step 540, the exemplary system charges the battery 130 in a second charging cycle. In some implementations, the second charging cycle corresponds to the second duty period 442. In some implementations, the second charging cycle corresponds to one or more time periods t1 404, and t3 404. In some implementations, the step 540 includes one or more of steps 542 and 544. At step 542, the exemplary system deactivates the first battery gate transistor 234. At step 524, the exemplary system activates the second battery gate transistor 238. The method 500 then continues to step 550.

At step 550, the exemplary system determines whether the second charging cycle is complete. If the exemplary system determines that the second charging cycle is complete, the method 500 continues to step 520. If the exemplary system determines that the second charging cycle is not complete, the method 500 continues to step 540. In some implementations, one or more of the charger controller 150, the first charger 140, and the second charger 142 determines whether the second charging cycle is complete based on one or more electrical, electronic, or logical conditions, or a combination thereof.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A device comprising:
a first battery manager circuit operatively coupled to a system voltage node and a battery node;
a second battery manager circuit operatively coupled to the system voltage node and the battery node;
a first charger circuit operatively coupled to the first battery manager circuit to receive a first current sensing input and transmit a first battery control signal; and
a second charger circuit operatively coupled to the second battery manager circuit to receive a second current sensing input and transmit a second battery control signal.

2. The device of claim 1, wherein at least one of the first battery manager circuit and the second battery manager circuit comprises a current sensor and a battery gate control circuit.

3. The device of claim 2, wherein at least one of the first charger circuit and the second charger circuit comprises a feedback transformer operatively coupled to the current sensor.

4. The device of claim 3, wherein the current sensor comprises a feedback resistor, and the feedback transformer is operatively coupled across the feedback resistor.

5. The device of claim 3, wherein at least one of the first charger circuit and the second charger circuit further comprises a control signal generator operatively coupled to the feedback transformer.

6. The device of claim 4, wherein the control signal generator is operatively coupled to a power converter.

7. The device of claim 6, wherein at least one of the first charger circuit and the second charger circuit further comprises a converter driver operatively coupled to the control signal generator.

8. The device of claim 6, wherein the control signal generator is operatively coupled to at least one of a buck stage and a boost stage of the power converter.

9. The device of claim 6, wherein the control signal generator of the first charger circuit is operatively coupled to a first power converter, and the control signal generator of the second charger circuit is operatively coupled to a second power converter.

10. The device of claim 3, wherein at least one of the first charger circuit and the second charger circuit further comprises a control transformer operatively coupled to the feedback transformer.

11. The device of claim 10, wherein the control transformer is operatively coupled to the battery gate control circuit of at least one of the first and the second battery manager circuit.

12. The device of claim 1, further comprising:
a first power converter operatively coupled to a first input voltage node and the system voltage node; and
a second power converter operatively coupled to a second input voltage node and the system voltage node.

13. The device of claim 12, wherein the first power converter and the second power converter each comprise at least one of a buck converter, a boost converter, and a buck-boost converter.

14. The device of claim 1, wherein the battery gate control circuit comprises a power MOSFET.

15. A method comprising:
sensing first and second charging currents;
charging a battery from a first converter based on the first sensed current; and
charging the battery from a second converter based on the second sensed current.

16. The method of claim 15, further comprising:
obtaining a charger current parameter,
wherein the charging the battery from the first converter further comprises charging the battery from the first converter based on the charger current parameter, and
the charging the battery from the second converter further comprises charging the battery from the second converter based on the charger current parameter.

17. The method of claim 16, further comprising:
obtaining a charger duty cycle parameter based on the charger current parameter,
wherein the charging the battery from the first converter further comprises charging the battery from the first converter during a first duty cycle based on the duty cycle parameter, and
the charging the battery from the second converter further comprises charging the battery from the second converter based on the charger current parameter.

18. The method of claim 17, wherein the charger current parameter comprises a first charger current parameter and a second charger current parameter.

19. The method of claim 18, wherein the charger duty cycle parameter is further based on a combination of the first charger current parameter and the second charger current parameter.

20. A device comprising:
a first battery manager operable to sense a first charging current;
a second battery manager operable to sense a second charging current;
a first charger circuit operable to obtain a first charger current parameter and to charge a battery from a first converter based on the first sensed current; and
a second charger circuit operable to obtain a second charger current parameter and to charge the battery from a second converter based on the second sensed current.
